(19) United States
(12) Patent Application Publication
(10) Pub. No.: US 2009/0300037 A1
(43) Pub. Date: Dec. 3, 2009

(54) Enhanced database structure configuration

(75) Inventor: Adi Kariv, Givatayim (IL)

Correspondence Address: WILMERHALE/NEW YORK, 399 PARK AVENUE, NEW YORK, NY, 10022, US

(73) Assignee: AMDOCS (ISRAEL) LTD., RA'ANANNA (IL)

(21) Appl. No.: 11/659,054

(22) PCT Filed: Aug. 12, 2004
(86) PCT No.: PCT/IL04/00741

§ 371 Date: Jul. 20, 2009

(51) Int. Cl. G06F 7/00; G06F 12/00

(52) U.S. Cl. 707/101; 707/100; 707/E17.045

(57) ABSTRACT

An enhanced data structure configuration that complies with the fundamental rules of the relational database model is disclosed. The data structure configuration comprises a data hub (88) logically overlaid on a relational data table (86). The data hub (88) is logically subdivided into intermediate time-sensitive storage spaces (90, 92, 94, 96) utilized for the partitioned storage of data objects.

### BACKGROUND OF THE INVENTION

1. Field of the Invention

The present invention relates in general to data processing, and in particular, to an advanced data structure configuration based on the conventional relational database model and enhanced with intermediate time-sensitive storage spaces and with self-modifying internally migrating data objects.

2. Discussion of the Related Art

Databases are computerized information storage and retrieval systems. A Relational Database Management System (RDBMS) is a database management system (DBMS) which uses relational techniques for storing and retrieving data. The most prevalent type of database is the relational database, a tabular database in which data is defined so that it can be reorganized and provide access to it in a number of different ways.

Regardless of the particular architecture, in a DBMS, a requesting entity, such as an application or the operating system, demands access to a specified database by issuing a database access request. Such requests may include simple catalog lookup requests or transactions and combinations of transactions that operate to read, to change and to add specific records in the database. These requests are made using high-level query languages such as the Structured Query Language (SQL). SQL is used to make interactive queries for getting information from and for updating a database, such as IBM's DB2, Microsoft's SQL Server, and other database products from Oracle, Sybase, and Computer Associates. The term “query” denominates one or more commands or a set of commands for retrieving data from a stored database. Queries take a form of a command language that lets programmers and programs to select, insert, update, search the location of data, and the like.

Relational databases are organized into tables which consist of rows and columns of data. The rows are formally called tuples or records. The database will typically have many tables and each table will typically have multiple tuples and multiple columns. The tables are typically stored on direct access storage devices (DASD), such as magnetic or optical disk drives for semi-permanent storage. An index is a type of table that is used to access data in a data table holding data to be accessed, such as employee data, warehouse data, accounting data, and the like. To distinguish between an index and a table holding data to be accessed, a table holding data to be accessed will be referred to as a “data table”. Both data tables and indexes are types of database objects that may be. stored in a database which is typically referred to as a relational database.

In a relational database data records are stored for long periods of time within static tables. The data records are typically identified by a so called primary key which is unique to the data record but only as long as the data record is stored in a single table. A required movement of a data record to a different data table typically necessitates the modification of the data record's primary key. Connectivity linking of a data record to other related or dependent data records that are stored in other tables is achieved by the use of the so-called “foreign keys”. A foreign key is basically a pointer value introduced into a specific record field that indicates the physical location of one or more related and/or dependent data records in one or more different tables. When the locations of the related and/or dependent records are changed as a result of required deletion and/or insertion operations or as a result of required record migrating operations into other tables, then both the primary key of the data record and the foreign key values in the dependant record should be changed. It would be easily perceived that during the operative life-cycle of a relational database record both the primary key and the included foreign keys could be changed several times. The identification of a record and the linking connectivity of a record to its dependant records are not time-consistent. Thus, the tracking and re-construction of the historical data manipulation processes performed on a record in various stages of its life cycle is highly problematic. The same difficulty arises when there is a need for tracking on a historical basis the time-dependant changes in the record properties as well as the time-dependant content changes, and time-dependent connectivity characteristics. The phenomenon generates two problems concerning relational database records that could be referred to respectively as 1) the “expiring identity” problem and 2) the “time insensitiveness” problem. For example, suppose a foreign key relationship was established between two data tables in a conventional relational database, such as Table A and Table B at some point in time T0, such that there is at least one field F1 in Table B that is defined as foreign key for Table A. If at some subsequent point in time T1 the validity of F1 in Table A is expired, such as the value of F1 is replaced by several new values, such as F2, F3, and the like, and/or the record in Table A is erased from Table A and inserted to Table C then the foreign key value determined at T0 in Table B becomes invalid As a result, subsequent to the point in time T1, the record in Table C will be inaccessible via the foreign key F1 in Table B.

There is a need for a new improved time sensitive and context based data structure configuration that could enable enhanced database records identification and mutual connectivity independent from physical transfer of records to new table locations and independent of data object life-cycle stages. The new data structure will preferably enable dynamic record storage instead of the presently used static long-term record storage and would negate the necessity for using foreign keys. Preferably the new data structure configuration would replace the conventional record deletion practices with record archiving in order to provide for historical time-sensitive accuracy where the need exists for record life cycle tracking

### SUMMARY OF THE PRESENT INVENTION

One aspect of the present invention regards a data structure configuration that complies with the fundamental rules of the relational database model. The data structure configuration comprises a data hub logically overlaid on a relational data table. The data hub is logically subdivided into intermediate storage spaces for the partitioned storage of data objects. A global header stored in a data object includes a unique global data object identification value, a unique storage space identification value, a unique primary key value, and a connectivity linkage value. The data structure configuration can further comprise a storage space attribute map associated with a storage space, the storage space attribute map includes metadata for defining the context, the content, the physical characteristics, and the functionality of a data field stored in the data object. The data hub can be is a multi-purpose multi-connectivity data hub or a single purpose data hub. The single purpose data hub can be a service hub. The service hub is a feeder hub including verified, validated and entry-authorized data objects. The service hub is a context hub including context metadata. The data hub can be a metadata hub.

The data structure configuration can further include a spectrum storage space as an inheritance source for the setting up of the storage space. The spectrum storage space includes an attribute map that includes metadata of basic field definitions, field characteristics, and field functionality. The data structure configuration further includes a delta map including one or more attributes complementing, replacing or suppressing metadata field definitions. The data object is transferable from a source storage space to a destination storage space. The structure, content, context, and functionality of the data object is modified in accordance with the definition metadata included in storage space attribute map associated with the destination storage space during the transfer of the data object from the source storage space to the destination storage space. The data object can be a primary record or a master record. The data object can be a secondary record or a servant record. The primary record is capable of internal inter-storage space migration, and of controlled self modification. The secondary record is capable of primary record tracking, primary record-dependent internal migration and primary record-controllable behavior. The data structure configuration further comprises one or more influence spaces defining a mutual domain for data objects having a space-based record connectivity between a leader record residing in a data hub in the influence space and one or more subordinate records residing in a data hub in the same influence space. Each influence space includes two or more data hubs maintained and managed via specific control tables in a pre-defined control storage space in a metadata hub. The leader record can have a pre-defined impacts on the at least one subordinate record.

A second aspect of the present invention regards a data structure configuration complying with the fundamental rules of the relational database model. The data structure configuration comprises a data hub logically overlaid a relational data table, the data hub logically subdivided into intermediate storage spaces for the partitioned storage of a data object, a global header stored in the data object including a unique global data object identification value, a unique storage space identification value, a unique primary key value, and a connectivity linkage value, and an intelligence header stored in the data object. The intelligence header includes a connectivity linkage value, a destination storage space identification value, a popularity management feature, a record collection management feature, and a storage space attribute map extension value. The intelligence header further comprises: one or more records having one or more common characteristic; and one or more record popularity indicators for determining movement options for a record. The intelligence header can be pre-determined and stored an intelligence header attribute map. It can be synthesized with a storage attribute map to make available the intelligence header attributes to the methods applied to the data structure configuration.

A third aspect of the present invention regards a method for moving an at least one data object across an at least two logical storage spaces. The method comprises obtaining source storage space identification and a source storage space attribute map, obtaining target storage space identification and a target storage space attribute map, obtaining the data object stored in the source storage space, and moving the data object to the target storage space in accordance with the target storage space attribute map. The method further comprises modifying the one or more data objects in accordance with the one or more target storage space attribute map. The data objects can be a primary record or a secondary record. The method further comprises backing up the data objects into an at least one archiving storage space.

A fourth aspect of the present invention regards a general purpose computing device for the storage and utilization of an enhanced database structure configuration. The computing device is having an input device, an output device, a communication device, a data bus a memory device, and a storage device. The storage device comprises an enhanced data structure configuration handler device and a relational database overlaid with an enhanced data structure configuration.

A fifth aspect of the present invention regards a a computer-readable storage medium containing a set of instructions for a general purpose computer device, the set of instructions comprising an enhanced data structure configuration generator. The set of instructions comprises a data object migration effector device; a data object structure and content modifier device. The set of instructions further comprises a data hub and storage space builder device.

### BRIEF DESCRIPTION OF THE DRAWINGS

The present invention will be understood and appreciated more fully from the following detailed description taken in conjunction with the drawings in which:

FIG. 1 is a block diagram describing an exemplary computing device on which the proposed enhanced data structure configuration could be installed and used, in accordance with a preferred embodiment of the present invention;

FIG. 2 is a schematic illustration of the enhanced data structure configuration, in accordance with a preferred embodiment of the present invention;

FIG. 3A is a more detailed schematic illustration of the enhanced data structure configuration, in accordance with a preferred embodiment of the present invention;

FIG. 3B is a schematic illustration of the storage space and the data objects stored therein, in accordance with a preferred embodiment of the present invention;

FIG. 3C is a schematic illustration of the structure of a data object stored in a storage space, in accordance with a preferred embodiment of the present invention;

FIG. 4A is a schematic illustration of the global header, in accordance with a preferred embodiment of the present invention;

FIG. 4B is a schematic illustration of the intelligence header, in accordance with a preferred embodiment of the present invention; and

FIG. 5 is a simplified flow chart describing a record movement operation across different tables, in accordance with a preferred embodiment of the present invention.

### DETAILED DESCRIPTION OF THE PREFERRED EMBODIMENT

An improved, new and novel relational database having an enhanced data structure configuration is disclosed. The novel time-sensitive data structure configuration complies with the relational database model. The data objects stored in the enhanced data structure configuration are uniquely identified by a life-cycle long identifier and by a time-sensitive and location-sensitive primary key. The enhanced data structure configuration provides time-sensitive two-way linkage connectivity among one or more independent primary records or master records and one or more related, dependent secondary records or slave records. The novel data structure configuration is enhanced by the introduction of one or more sets of intermediate time-sensitive storage spaces built within and associated with conventional relational tables. The storage spaces incorporate a set of uniquely identified primary data objects that could be logically associated with and physically linked to one or more sets of secondary data objects. The one or more set of primary data objects are provided with the capabilities of independent or controlled self modification regarding the structure, the content, the context, and the functionality thereof. The one or more set of primary data objects are further provided with independent, semi-independent or controlled internal migration options across diverse intermediate storage spaces, with automatic generation of new dependent data objects, and with controlling ability regarding the structure, the content, the context, and the functions of existing dependent data objects. The one or more sets of secondary data objects are logically associated and physically linked to the required primary data objects and depend on the existence, on the location and on the characteristics of the primary data objects. The one or more sets of secondary data objects are utilized as auxiliary containers of information concerning the primary data objects. The one or more sets of secondary data objects are provided with the capabilities of primary data object tracking, primary data object-dependent internal migration, and primary data object-controllable behavior. The data objects associated with the diverse storage spaces are capable of being cloned for providing load balancing and for being backed up or archived for providing historically accurate presentation and re-construction. In the novel, enhanced, time-sensitive data structure configuration, the individual relational tables constituting the relational database are partitioned into diverse storage spaces. The relational data tables are referred to as either data hubs or as service hubs. The data and service hubs could be spread across one or more host RDBMS where each host RDBMS could be different database products supplied by different vendors, The data and s could be used as a computational grid and thereby could support requests for grid computing. The storage spaces are implemented through the addition of specific header information to data objects stored in the storage spaces, such as member records that were registered and introduced into the storage spaces. The information included in the header comprises a group of global control fields comprising a global header, and a group of intelligence control fields comprising an intelligence header. The global header fields include typically an identification of the current storage space, a unique permanent identification of the of the data object maintained across the diverse storage spaces, storage space control-specific information, a variable storage-space specific primary key, and the like. The interface control fields include typically inter-object linking pointers, and the like. Each storage space is typically associated with a storage space attribute map where the map carries metadata that defines the attributes of the data objects located in the associated storage space. The storage space attribute map is operative in the manipulation of the data object field values consequent to the introduction of the data object into the storage space. During the life-cycle of the data object, the data object is capable of internally migrating across diverse storage spaces where the movement of the data object is controlled by specific launcher or triggering functions based on application events, such as modification of data object field values, timing information, manual manipulation, screen events, batch processing stages, and the like. The movement of the data objects and the consequent introduction of the data objects into dynamically defined storage spaces effects modifications in the structure, in the content, in the context, and in the functionality of the data objects where the changes are based on the metadata definitions of the appropriate attribute map associated with the current storage space. Where the data object is a primary data object then the movement thereof may further effect the movements of one or more related and dependant secondary data objects. Prior to the movement of the data objects a backup copy of the objects is generated to provide for a historically accurate image of the entire data structure along the time axis and for a required re-construction of the database. The data objects are cloned into specific cloning spaces, historical storage spaces, or archiving spaces in order to provide for historically accurate presentation along the time axis. The unique identification of the data objects and the unique linking connectivity values among the related data objects is maintained appropriately along the entire life cycle of the data objects even consequent to inter-storage space traffic of the data objects. The maintaining of the unique time-sensitive identity of the data object is accomplished via the utilization of specific global header fields. The maintaining of the unique time-sensitive and migration-independent inter-data object connectivity linkages is accomplished by the utilization of specific fields in the intelligence header. During a required movement of a data object between storage spaces the destination storage space is defined by specific field value in the intelligence header.

When setting up an application for each storage space a specific storage space attribute map is established. The storage space attribute maps stores metadata for defining the attributes of the data objects columns. When a primary data object is registered into a storage space the fields thereof are manipulated in accordance with the metadata definitions of the storage space attribute map. The definitions of the storage space attribute map are time-sensitive. Thus, fields that are operative in specific stages of the data objects' life cycle appear only in the attribute maps associated with storage spaces designed to store data objects at that specific stages of the life cycle. The setting up of an application involves the generation of context libraries, context chains, the insertion of the context chains into the storage space attribute maps and the manual customization of the storage space attribute maps and storage space contents.

The enhanced data structure configuration includes several components, such as spectrum storage spaces for providing assistance in the construction and interpretation of storage space attribute maps. A spectrum storage space is used as a source for inheritance to operative storage spaces. The spectrum storage space has an attribute map that includes various basic field definitions. The spectrum storage space map is utilized as a basic input to a unique storage space map generator mechanism that is designed for the creation of operative storage space attribute maps based on spectrum storage space inheritance. The operative storage space attribute map generation mechanism includes an option of creating original definitions, neutralizing some definitions and/or modifying some definitions of the base attributes. The spectrum storage space is a specific attribute map to inherit physical storage spaces. For example, a calling card spectrum record will include the entire set of fields used during the calling card life cycle including periodically reset expiration date,

Another useful concept provided by the proposed apparatus of the present invention is the virtual storage space. A virtual storage space is an attribute map of a regular relational database table without any extensions. The table may be surrounded by regular storage spaces managing the life cycles of the data in the virtual storage space.

Another useful component associated with the enhanced data structure configuration is referred to as the delta map. A delta map is a list of attributes complementing, such as a “reason for leaving” field, a “date of leaving” field, and/or replacing and/or suppressing, such as a “promotion date” field, existing attributes in some data object in a storage space A in order to route it to a storage space B. An influence space or a connectivity space defines a mutual domain for data objects having a primary-secondary or master-slave or leader-subordinate record connection, such as between a primary record identification field in global header and parent identification field in a global header in secondary records. A more detailed description of the above-mentioned features, components, options and mechanisms of the present invention will be set forth herein under in association with the following drawings.

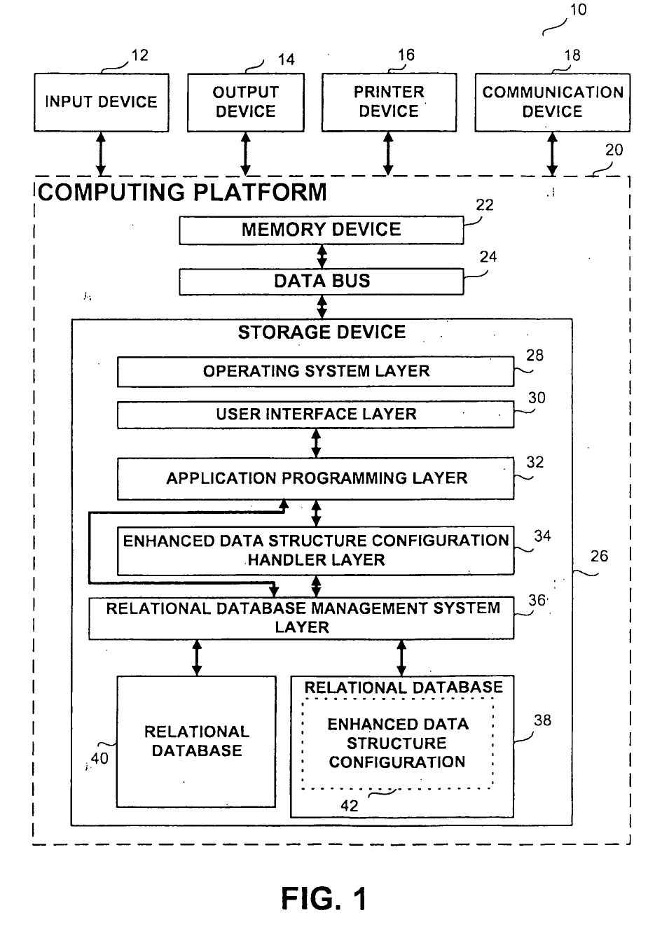

Referring now to FIG. 1, computer platform 20 is a computing hardware device, such as a mainframe computer, a minicomputer, a desktop computer, a personal digital assistant, a microcomputer, and the like, having sufficient computing resources in order to run and execute applications utilizing a relational database. A computer is a device that accepts information in the form of digitalized data and manipulates it for some result based on a program or lo sequence of instructions on how the data is to be processed. Computers also include the means for storing data including the program, which is also a form of data for some necessary duration. A program may be invariable and built into the computer and called logic circuitry as it is on microprocessors or different programs may be provided to the computer loaded into its storage and then started by an administrator or user. Computing platform 20 includes a memory device 22, a data bus device 24, and a storage device 26. Memory device 22 is the electronic holding place. for instructions and data that the computer's processor can reach quickly. When the computer is in normal operation, the memory device usually contains the main parts of the operating system and some or all of the application programs and related data that are being used. Memory is often used as a shorter synonym for random access memory (RAM). Data bus device 24 is the data path on the computer's motherboard that interconnects the processor with attachments to the motherboard in expansion slots such as hard disk drives, CD-ROM drives, graphics adapters, and the like. Several peripheral units, such as input device 12, output device 14, printer device 16, and communication device 18 are connected to the computing platform 20 where the peripheral are connected to the platform 20 either via pre-defined or universal I/O ports (not shown). Input device 12 is preferably a video terminal with an associated keyboard and pointing device utilized by a user to introduce commands and data into the computing platform 20. Input device 12 could further be a CD-ROM device, a tape device, and then like. Output device 14 is typically a video terminal used to display information and messages from the platform 20 to the user thereof. Printer device 16 accepts text and graphic output from a computer and transfers the information to paper, usually to standard size sheets of paper. The communication device 18 is preferably a high speed modem or a network interface card (NIC). The storage device 26 is preferably a Direct Access Storage Device (DASD), such as a magnetic disk, a hard disk or redundant array of independent disks (RAID) with sufficient storage capacity for holding a plurality of software components and associated data structures. The software components and the associated data structures control the operation of the platform 20, maintain the constituent software entities of the platform 20 and execute applications installed on the platform 20 in accordance with the objectives of the users of the platform 20. In the preferred embodiment of the invention, the storage device 20 holds an exemplary set of software component layers and an exemplary set of data structures. Thus, device 20 includes an operating system layer 28, a user interface layer 30, an application programming layer 32, an enhanced data structure configuration handler layer 34, a relational database management system layer 36, a conventional relational database 40, and a relational database 38 with an enhanced data structure configuration 42 “grafted” on, “overlaid” on, or logically defined on the relational database structure. The operating system layer 22 includes a plurality of software programs and associated control data structures that control the operation of the platform 20, provide utilities, determine running priorities, handle I/O operations, establish communications, and manage the day-by-day operation of the platform 20. User interface layer 30 is a set of software modules responsible for interfacing between a human user and the appropriate computing interface in order to enable meaningful communication between the user and the program modules running on the platform 20. The most prevalent type of a user interface is the Graphical User Interface (GUI). Application programming layer 32 includes a plurality of software routines constituting a user application. The term user application is also referred to as application programs. Application programs are programs designed to perform a specific function directly for the user or, in some cases, for another application program. Examples of applications include word processors, database programs, Web browsers, development tools, drawing, paint, image editing programs, and communication programs. Applications use the services of the computer's operating system and other supporting applications.

Still referring to FIG. 1 a relational database management system (RDBMS) is a program that lets you create, update, and administer a relational database. Most commercial RDBMS use the Structured Query Language (SQL) to lo access the database, although SQL was invented after the development of the relational model and is not necessary for its use. The leading RDBMS products are Oracle, IBM's DB2 and Microsoft's SQL Server. Relational database management system layer 36 includes a set of software programs that provide relational database access services to application programs. Access services include database queries, inserts, deletions, copies, and the like. System layer 35 interfaces directly with relational database 40 and relational database 38. A relational database is a collection of data items organized as a set of formally-described tables from which data can be accessed or reassembled in many different ways without having to reorganize the database tables. The standard user and application program interface to a relational database is the structured query language SQL. SQL statements are used both for interactive queries for information from a relational database and for gathering data for reports. A relational database is a set of tables containing data fitted into predefined categories. Each table sometimes referred to as “relation” contains one or more data categories in columns. Each row contains a unique instance of data for the categories defined by the columns. For example, a typical business order entry database would include a table that described a customer with columns for name, address, phone number, and so forth. The definition of a relational database results in a table of metadata or formal descriptions of the tables, columns, domains, and constraints.

Still referring to FIG. 1 relational database 40 is a conventional relational database operating in accordance with the features, options, and operating mechanisms of the relational database management system layer 36. The relational database management system layer 36 manages the operation of the relational database 38 in a similar manner. The difference between the operation of the two databases 40 and 38 is provided by the operation of the enhanced data structure configuration handler layer 34. Layer 34 is a set of computer modules that are operative in the “overlaying” of the basic structure and logic of a relational database with the structure, and logic of an enhanced data structure configuration 42. The “overlaying” of the relational database 38 by the enhanced data structure configuration 42 provides to the relational database 38 substantially enhanced operative capabilities, advanced options, additional features, superior functionality, sophisticated user interfaces, and the like. The enhanced data structure configuration 42 enables the efficient storage of and the advanced processing of data objects having unique, steady and life-cycle-long identification and stabile time-sensitive, storage space-sensitive data-object-to-data-object connectivity characteristics. Additional features and characteristics of the enhanced data structure configuration 42 will be described herein under in association with the following drawings.

Note should be taken that the compute platform and the constituent elements thereof as were described herein above are exemplary only and were presented in order to provide a coherent and ready understanding of the present invention. Several standard key computing elements were not shown. For example, in a realistic environment, a computing platform could several diverse applications and optionally several databases with diverse types, such as hierarchical databases, network databases and the like.

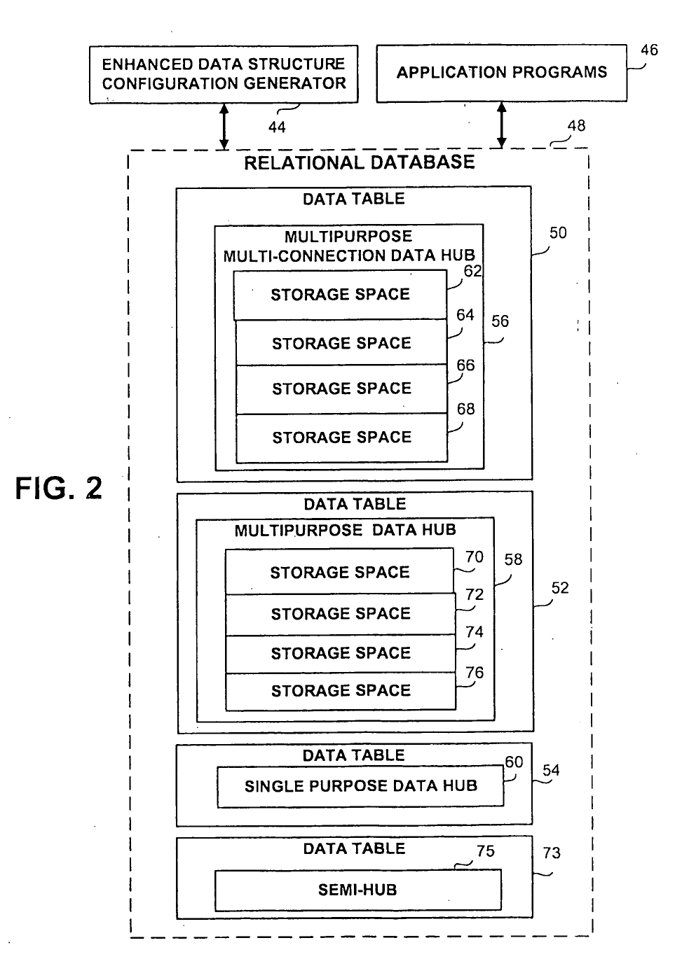

Referring now to FIG. 2 the relational database 48 includes a set of relational data tables, 50, 52, 54, and 73. The data tables 50, 52, 54, 73 are utilized by the enhanced data structure configuration 42 of FIG. 1 as containers to the data structure elements of the configuration 42 of FIG. 1. Thus, table 50 holds multi-purpose multi-connectivity data hub 56, data table 58 holds multi-purpose data hub 58, data table 54 holds single purpose data hub 60, and data table 73 holds a semi-hub. In practical terms, table 50 is identical to data hub 56, table 52 is identical to data hub 58, table 73 is identical to semi-hub 75, and table 54 is identical to data hub 60. Multi-purpose multi-connectivity data hub 56 is logically divided into a set of storage spaces 62, 64, 66, 68. The storage spaces 62, 64, 66, and 68 store one or more data objects (not shown). Multi-purpose data hub 58 is logically divided into a set of storage spaces 70, 72, 74, 76. The storage spaces 70, 72, 74, 76 store one or more data objects (not shown). Single-purpose data hub 60 stores one or more data objects (not shown). Semi-hub 75 stores one or more data objects (not shown). A data hub is defined as a relational database table with specific characteristics. The structural characteristics concern the inclusion of a global header (not shown) in the data objects of the data hub with global header fields. The critical control fields of the global header are as follows: a storage space identification, a concatenated primary key, a unique data object identification number, and a pointer to one or more dependent data objects in the same data hub or in a different data hub. The data record in the data hub further includes at least three sequences of casual fields. The fields include at least two string-valued fields, at least two number-valued fields, and at least two date-time-valued fields. A data hub is also provided with a unique identification. In the preferred embodiment of the invention, the data hub identification includes an application code, a task code, a size code, and a data hub number. A multi-purpose multi-connectivity data hub such as data hub 56 includes one or two particular headers, such as a global header (not shown) and an intelligence header (not shown). The data hub 56 is divided into physical subdivisions referred to as storage spaces 62, 64, 66, 68. A new data object, such as a data record, (not shown) is registered into a storage space 62, 64, 66, 68 when the unique data object identification field in the global header referenced typically as the GUMI receives a value. The GUMI will remain identical for the entire life cycle of the data object notwithstanding storage space locations, structural changes, content changes, and the like. The registration of the data object into the storage space further involves the setting of the storage space identification field in the global header to the unique identification number of the storage space. The value of this field is modified during the routing of the data object to a different-storage space. In addition a specific primary key field value is set in the global header. The primary key could change during the life cycle of the data object, for example, during the routing of the data object to a different storage space. The data hub further includes a particular control storage space (not shown) that includes a list of all the storage spaces in the data hub. The data object registered in a multi-purpose multi-connectivity data hub 56 could have an intelligence header (not shown). The intelligence header includes fields operative in the indication of connectivity between the data object and other related or dependent data objects registered either in the same data hub or in different data hubs. The data objects introduced into the multi-purpose data hub 58 could have a global header but no intelligence header is generated. Thus, the multi-purpose data hub 58 stores data objects with no connectivity linkages. Data objects registered in the storage spaces 70, 72, 74, 76 of data hub 58 could be relational table records extended with fields of the global header. During the lifetime of the data object fields constituting an intelligence header could be added to the data object consequent to the migration of the data object from a multi-purpose data hub to a multi-purpose multi-connectivity data hub. The behavior of the single purpose hub 60 is pre-defined for a range of applications. Thus, the hub 60 is similar to a service hub but it provides service for a limited range of applications. The semi-hub 75 utilizes predefined fields in the RDBMS catalog which are partly or fully mapped to the storage space of the semi hub 75. The semi-hub 75 may be created from an existing relational data table and therefore the fields of the global header are not mandatory. In addition the semi-hub 75 is not typically subdivided into distinct storage spaces. The semi-hub 75 could be a service hub, such as a feeding table, a temporary table, a work table, an archive table, a trash table, and the like. A service hub is used during the life cycle stages of the data for various service functionality, such as preparing data to appear in the data hubs, to route data inside and across data hubs and to move data to conceptual freezers, archives, and trash bins at the end of the data life cycle. A semi-hub is a regular relational database table defined with RBMS “Create Table” command, extended with a global header and optionally with an intelligence header. A semi-hub provides regular relational database tables with partial hub functionality via the added headers. Thus, a semi-hub could be managed by applications that are unaware of the added headers. For example, semi-hubs could be handled either as regular CRM customer tables or as computational grids where the same primary key could be maintained for both operations. Certain logical rules may cause the activation of a triggering mechanism in order to modify the identification of the storage space associated with a semi-hub. For example, routing of records inside a semi-hub is implemented by the changing of the storage space. The existence of foreign keys within a record in a semi-hub typically prevents the movement of the record outside the table. A semi-hub further provides the option of utilizing data types not typically supported by underlying RDBMS, such as bit fields or Binary Large Objects (BLOB) fields for image storage. One exemplary application involves the extension of an existing exchange rates table in order to provide historically improved exchange rate granularity. Conventional relational tables and their associated schema could be loaded into the storage spaces and storage maps of the proposed data structure configuration without changing the structure of the schema. Note should be taken that a semi-hub could be extended with a global header and eventually with an intelligence header.

Note should be taken that in the preferred embodiment of the invention, the manner of the construction of the primary key for a record in a service hub could differ from the manner of construction of the primary key for a record in a data hub. The reason has to do with the typically different behavioral patterns of a record in a data hub and the same record in a service hub. A data record in a data hub is typically unique during its life cycle and appears in the data hub only once. During the same life cycle several copies of the same record could be inserted into a service hub, such as an archive hub, for example. In order to provide additional access-sensitivity and inter-hub unique identification for the record in the service hub the original primary key associated with the record in the data hub should be modified in a pre-determined manner for all the copies of the record in the service hub. In the preferred embodiment of the invention, a primary key is structured according to a “build value” taken from a storage space where all storage spaces are registered and managed. The primary key could be concatenated from field values in the record or could be set by in accordance with the value of the GUMI only. When based on the field values of the record the construction of the primary key involves the attachment of the storage space typically prefixed with a pre-determined control character, such as a ‘#’ or the like. A representative example for the construction of the primary key in a Voice-over-IP (VoIP) billing record could involve the concatenation of the following record-specific values: a) a calling card number, such as “250100910”, b) a point in time in milliseconds on a specific base, such as “1204006800”, c) pre-defined control character, such as “#” and a storage space identification, such as “218045”, The completed primary key will be a string having the value of “250100910;1204006800#218045.

The record in a data hub includes a global header, an optional intelligence header and a pre-defined group of fields with initially unassigned types. In the preferred embodiment of the invention the fields of the data record are built by using a specific structure formula. The formula is in the following format: n1(m1[NCD]+m2[NC]+m3[N]+ . . . , where N1=repeating factor of internal pattern, and N (numeric), C (string), D (date time) are the basic data types used. The total number of these fields and their appearance pattern determines the model identification of the data hub. In the preferred embodiment of the invention the group of fields is built by using a specific structure formula. The formula is in the following format: n1(m1[NCD]+m2[NC]+m3[N]+ . . . , where N1=repeating factor of internal pattern, and N (numeric), C (string), D (date time) are the basic data types used. Thus, a small-sized record could include 20 fields defined by the model formula 5[NCD]+15[NC] while a medium-sized data record could include 30 fields defined by the model formula of 5[NCD]+15[NC]+3[NCD]+7[NC]. If a small-sized module formula is included in the medium-size model formula from the first position then two data hubs are overlapping. When two data hubs are overlapping then very basic data transfer operations are enabled. When moving the small-sized record to the medium-sized record then the entire set of fields will be transferred while when moving the medium-sized record to the small-sized record the fields not defined in the small-sized record will be truncated.

Still referring to FIG. 2 data hubs are characterized by the types thereof. The main types of data hub include operative data hubs and service hubs. The common sub-types of the service hub type could be feeder hubs, freezer hubs, trash hubs, search results hubs, context hubs, log hubs, archive hubs, history hubs, and the like. Feeder hubs are intermediates storage areas for validated and authenticated data waiting for movement triggering in order to be moved to storage spaces. Freezer hubs are storage areas holding saved storage space states. Trash hubs store logically deleted data objects from various storage spaces. Search result hubs holds data objects located during a search. Context hubs are vocabularies of common usage fields and log hubs support the database backup activities. Data objects in data hubs include sequences of numeric-valued, string-valued, date-time-valued fields (data slots). The definition of the structure, characteristics and functionality of the fields is stored in specific storage space attribute maps.

Still referring to FIG. 2 the storage spaces 62, 64, 66, 68, 70, 72, 74, 76 are major components of the enhanced data structure configuration. A storage space is a logical division of a data hub. A storage space is uniquely identified by a unique storage space number in the global header and described by metadata stored in a storage space attribute map. The description does not include “future” fields. A storage space is the basic unit of storage and routing in the enhanced data structure configuration. The data objects residing in storage spaces are routable subject to specific conditions and circumstances to new locations in other storage spaces. The storage space attribute maps are also stored in a special storage space uniquely identified by a pre-defined identification number (not shown). Note should be taken that when it is determined that no future changes it will be applied to a specific storage space the storage space attribute map could be locked by the operation of a context manager. The finalizing of a storage space attribute map is very useful for learning and searching purposes.

Still referring to FIG. 2 an enhanced data structure configuration generator component 44 is linked to relational database 48. The functionality of the generator component 44 is to set up an application-specific enhanced data structure configuration and to upgrade the configuration after activation. A set of related application programs 46 is linked to the relational database 48 in order to submit access requests on the data objects stored in the enhanced data structure configuration. The application programs 46 are linked to the database 48 via the enhanced data structure configuration handler layer 34 of FIG. 1 and through the relational database management system layer 36 of FIG. 1. Note should be taken that the relational database, the overlaying enhanced data structure elements, and the linked software modules are exemplary only and were presented in order to provide a coherent and ready understanding of the present invention.

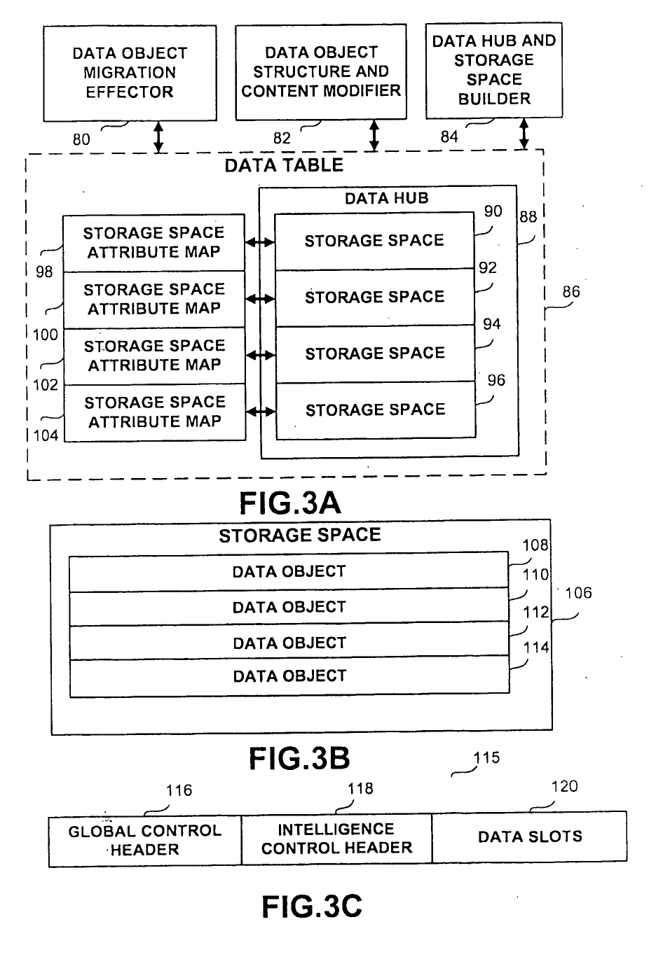

Referring to FIG. 3 relational data table 86 is “overlaid” by data hub 88. The term “overlaid” refers to the fact that a data hub is equivalent to a relational data table. The data hub 88 is operationally supported by the RDBMS. The RDBMS handles the data hub 88 and provides services, such as responding to access requests, enabling queries, performing record insertion, record deletion, and the like in the manner substantially similar to the handling or service provision to the relational data table 86. These services are provided by the appropriate software utilities of the RDBMS system. From the point of view of the appropriate software routines of the RDBMS the data hub 88 is a relational data table 86. Data hub 88 is logically subdivided into storage spaces 90, 92, 94, 96. The characteristics of the data and control fields of a data object registered in a storage space 90, 92, 94, 96 are kept as definition metadata in the storage space attribute maps 98, 100, 102, 104, respectively. A data object migration effector component 80 is linked to the data table 86. The effector component 80 could be an application module that initiates a movement of a data object consequent to the occurrence of an event, such as a screen event or a timing event. The effector component 80 could be a configuration handler layer module associated with specific timing devices, such as the system clock or other operating system control tables in order to initiate data object movement between storage spaces in accordance with the current date-time value or an expired time period in a pre-defined manner. Note should be taken the data object movement parameters, such as the destination storage space, and the like are stored in the intelligence header included in the data object. The data object structure and content modifier component 82 is linked to the data table 86. The modifier component 82 could be an application module that-initiates the modification of the data object prior to, during or consequent to movement of the data object from the source storage space to a destination storage space. The modifier component 82 could be a configuration handler layer module associated with the data object migration effector 80 or with any other user-operated data object modifier program. Note should be taken the data object modifier parameters, such as the structure of the data object (number of fields, field pattern, field characteristics, and field values) are stored as metadata definitions in the storage space attribute maps 98, 100, 102, 104 associated with the storage spaces 90, 92, 94, 96. The storage space builder 84 is an exemplary software module the responsibility of which is the generation of a storage space either during the setting up of the application or at any time during the life time of the application. Storage space attribute maps 98, 100, 102, 104 are metadata lists of that include computed assignments of the properties of the data objects physical data fields in a storage space. Storage space attribute maps 98, 100, 102, 104 inherit the metadata list from a spectrum storage space attribute map (not shown) that include basic metadata definitions. During in building of a storage space attribute map from the spectrum storage space attribute map some of the definitions are neutralized, other attributes are added and yet other attributes are replaced. Storage space attribute map definitions are stored in a separate specific storage space (not shown). Note should be taken that the above-described data structure configuration elements and software program components are exemplary only and were presented in order to provide a coherent and ready understanding of the present invention.

Referring now to FIG. 3B, an exemplary storage space 106, stores a set of data objects 108, 111, 112, 114. The storage space 106 is a data container to store data objects at a specific stage of the life cycle thereof. Thus, for example in a personnel management system the information concerning an active employee lo and kept in an employee data object, such as a data record, and could be stored in an “active employee” storage space. Consequent to the resignation of the employee, the data object describing the employee is moved to a “resigned employee” storage space and deleted from the “active employee” storage space. Note should be taken that the destination storage space is defined by a “destination” field kept in the intelligence header of the data object. In accordance with the metadata definitions kept in the storage space attribute map associated with the “resigned employee” storage space the data object of the resigned employee is optionally modified. The values of one or more previously active data fields could be changed, such as, for example, the status of the employee could be set to a code indicating that the employee resigned. More importantly, additional data fields could be added to the data object potentially increasing the size of the data object, such as date of resignation, reason for resignation, and the like. If the resigned employee is eligible to severance payment or pension then one or more dependent data object will be generated automatically concerning the financial arrangements of the resigned employee. One such dependant data object could be a data object storing suitable financial data. The dependant data object is registered into a “resigned employees severance payments” storage space and a connectivity linkage is generated between the data object of the resigned employee and the severance payment data object. The connectivity is accomplished via specific connectivity linkage fields of the intelligence header in the employee data object and the severance payment data object. Mutual two-way pointers are generated between the related data object enabling ordered access from the employee data object to the financial data object and enabling access from the financial data object back to the employee data object. During the transaction, the global unique data object identification (GUMI) is not modified in the employee data object although the primary key of the data object may change during the routing. The deletion of the employee's data object from the original “active employee” storage space effects the cloning of the data object and the insertion thereof to a pre-defined archive data hub to provide for historical processing, historical queries, reports, and the like. The archive hubs provide for time-sensitive historical views of the information kept in the enhanced data structure configuration.

Note should be taken that a record may move into a storage space without an intelligence header. In such a case the record is no more a subject for further routing and therefore will remain in the storage space unless a specific privileged process effects the movement thereof to a service hub, such as an archive hub for example.

Referring to FIG. 3C a typical and active data 115 object kept in a storage space may include a global header 116, an intelligence header 118, and one or more data slots 120. The control data associated with the global header 116 and the intelligence header 118 will be described in further detail herein under in association with the following drawings. The data slots 120 store various fields defined and generated by the definition metadata in the storage space attribute map associated with the storage space wherein the data object is stored. The number, context and content of the data fields could be substantially modified during the life-cycle of the data object consequent to the routing of the data object to a different storage space either in the same data hub or in a different data hub.

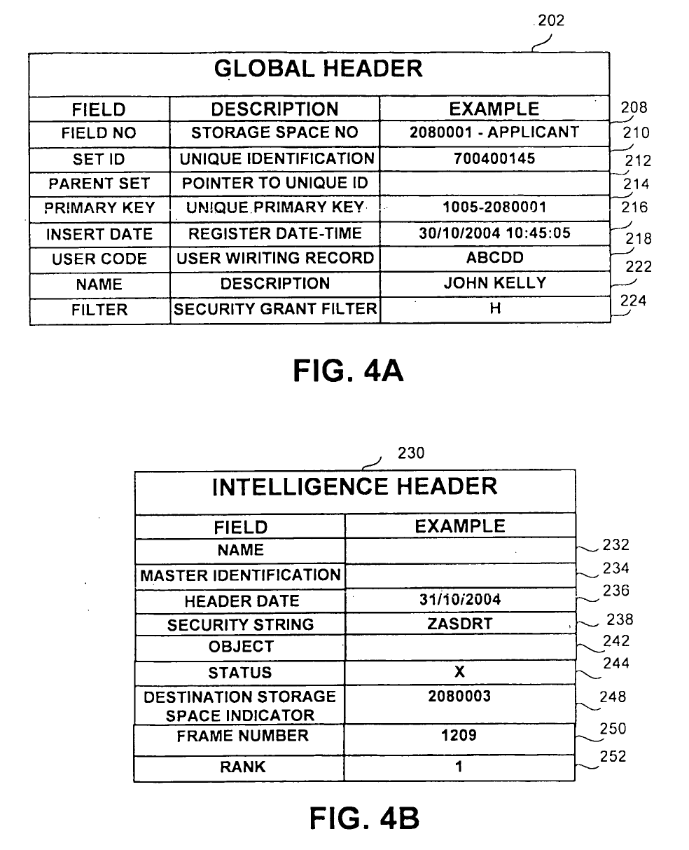

Referring now to FIG. 4A and FIG. 4B a storage space is implemented in a relational table by the introduction of a global header that includes control fields. The storage space implementation involves the logical partitioning of the relational table by pre-defined storage space identification. The relational table could a multi-purpose, multi-connectivity synthetic table with casual data fields or a regular single-purpose relational table. In the context of the enhanced data structure configuration the relational tables are referred to as data hubs. In a multi-purpose data hub an additional control header with appropriate control fields is added. The additional control header is referred to as the intelligence header 230. The intelligence header is utilized either for inter-storage space connectivity purposes, for inter-storage space activities or for any other control functions. The structure, functionality, responsibility, and the content of an intelligence header could be storage space specific. Some storage spaces have no intelligence header.

Referring now to FIG. 4A specifically, the global header 202 typically includes the following fields: storage space number 208, data object unique identification 210, pointer to other data object unique identification 212, primary key 214, date and time of data object registration into the storage space 216, user code 218, name of data object 222, and security filter 224. Storage space number 208 uniquely identifies the storage space. The identification could be in numeric format, or in alphanumeric format. When the data object moves to a different storages space the value of the field 208 is automatically modified to reflect the unique identification of the new storage space. Data object unique identification 212 identifies the data object uniquely and the value is typically maintained during the entire life cycle of the data object. Field 212 typically remains the same during data object movements, data object cloning, updates, and the like. During the introduction of a new data object into the data structure configuration the data object is assigned a unique identification where the value could be a random number, a specifically computed number or a combination thereof. The data object unique identification 210 enables tracking the data object during the entire life cycle of the record. Pointer to unique identification 212 is a pointer value that connects a primary record to a secondary or dependent record and a secondary record to a primary record. The field 212 enables a secondary record to track and locate the primary record thereof even when the primary record has been moved to a new storage space and as a result the primary key of the record was changed. In the same manner field 212 provides the option to a primary record to track and locate the dependent records thereof. Primary key 214 is a unique key that identifies the data object as long as it is stored in a specific storage space. The primary key 214 is a value that could be logically determined, or could be suitably computed or could be randomly allocated. Primary key 214 could be modified consequent to an inter-cabinet movement of a data object where the modification of the primary key 214 is determined in accordance with the destination storage space attribute map. Insert date filed 216 indicates the date and time of the insertion of a data object into the storage space. User code field 218 identifies the user responsible for the registration and insertion of the data object into the storage space. Name field 222 identifies the data object in a human-readable manner and security filter field 224 stores a pre-defined security code that provides the data object from unauthorized access, queries, modifications, and deletions. Note should be taken that the above-described control fields of the global header are exemplary only. In other preferred embodiments of the invention, the type, functionality and structure of the header could be different. For example, in other preferred embodiments the primary-secondary data object connectivity could be accomplished by the intelligence header or any other similar mechanism. Yet in other preferred embodiments multiple control fields regarding the same functionality could be used, such as several destination storage space fields to provide to alternative routings accompanied with a routing code. The global header could further include alternative archive routings, and the like. It would be easily perceived that when no routing is defined to data objects then the destination storage space field could have a null value. In yet further preferred embodiments of the invention various other uses of the global header could be contemplated.

Referring now to FIG. 4B specifically the intelligence header 230 typically includes the following fields: name field 232 identifies the data object in a human-readable manner, master identification 234 is a pointer value utilized in the intelligence header of a secondary record in order to enable the location of a primary record the dependant record of which is the secondary record. Header date 236 indicates the date for the registering and insertion of the intelligence header into the data object. Security string 238 provides protection against unauthorized access, queries, insertion, and deletion. Destination storage space filed 248 stores the destination storage space identification to where the data object is routable. Typically a data object life cycle course is pre-determined such that it is known that from a specific storage space A the data object could be routed only to storage space B. Thus the function of destination storage space field 248 is to store the potential destination of the data object that is associated with a future migration. The intelligence header 230 further includes a rank value 252 for record popularity management. Rank value 252 could be optionally affected by specific methods operative in the measurement of “popularity” of the data object or some context of the data object. For example, a record representing a Voice over IP (VoIP) address could include a rank value. When the VoIP address is “popular”, such as by receiving a relatively high of calls then the record could be given a popularity rank based on the number of calls to the address. When the value of the rank 252 is modified specific pre-defined methods could be activated, such as, for example, setting up the destination storage space identification 248 to a new value. The intelligence header 230 further includes a frame number value 250 for managing collections of records with pre-defined commonality, such as records that were registered about the same time into the data structure. For example, currency rates registered at 12:45:15 may have a different frame number from currency rates registered at 12:48:10. The structure of the intelligent headers is pre-defined and stored in a specific group of storage spaces, referred to as the intelligence header attribute maps. The intelligence header attribute maps could be synthesized with the storage space attributes to make available the intelligent header attributes to methods applicable to the data structure configuration.

Note should be taken that the above-described control fields of the intelligence header are exemplary only. In other preferred embodiments of the invention, the type, functionality and structure of the header could be different. For example, in other preferred embodiments the primary-secondary data object connectivity could be accomplished by the global header or any other similar mechanism. Yet in other preferred embodiments multiple control fields regarding the same functionality could be used, such as several destination storage space fields to provide to alternative routings accompanied with a routing code. The intelligence header could further include alternative archive routings, and the like. It would be easily perceived that when no routing is defined to data objects then the destination storage space field could have a null value. In yet further preferred embodiments of the invention various other uses of the intelligence header could be contemplated.

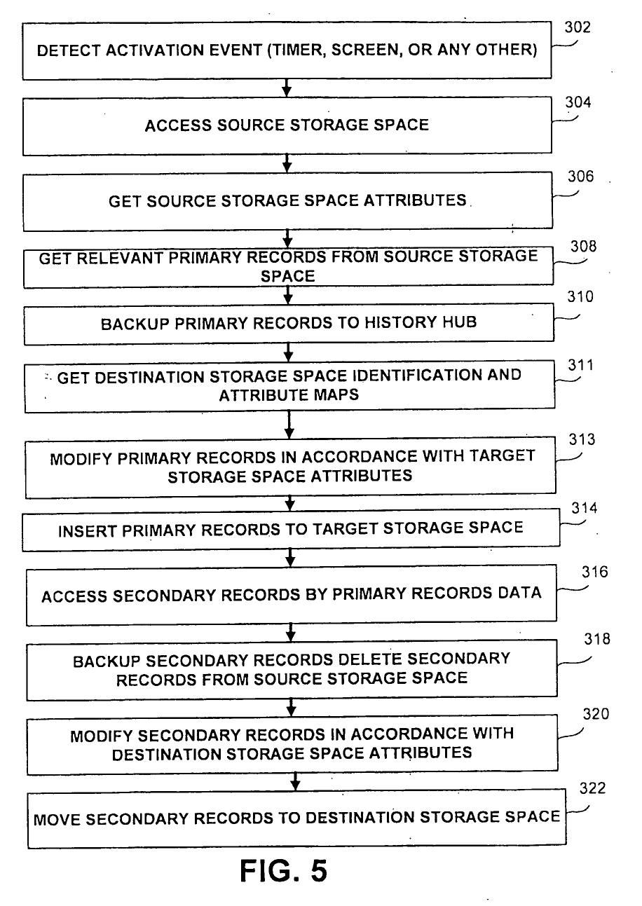

Referring now to FIG. 5 it is a common characteristic of data processing systems utilizing databases that during a data object's life cycle a data object, such as a data record is successively modified in order to reflect changes effected by fixed-path or alternative-path processing. In conventional relational database management systems a major processing stage typically involves the transfer of the data object from one relational data table to another data table. Thus, for example, in a personnel management system the data record of an employee is first stored in a “temporary employees” table. After a pre-determined period of time expires or following manual intervention the status of the employee is modified and in order to accomplish efficient processing and internal storage consistency the data object representing the employee is transferred into a “permanent employees” table. Yet again consequent to a major processing stage the status of the employee may be upgraded to “management status” and as a result the data record of the employee is transferred to a “manager class employees” table. It will be easily understood that each inter-table transfer involves potential modifications in the employee data, potential changes in the structure of the employee data object, and possible modifications of the primary key of the data record. Since the transfer of a data record involves the deletion of the source record it would be easily understood that the currently existing data object is not time-sensitive or incapable of providing a historically accurate image. Due to the possible changes of the primary key the handling of the secondary records depending on the employee records, such as family member records, salary records, professional achievement records, health records, and the like, is substantially problematic.

Still referring to FIG. 5 the proposed enhanced data structure configuration provides solutions for the problems and disadvantages inherent in the conventional relational database management systems. The exemplary flowchart presenting on the drawing under discussion describes an exemplary inter-storage space movement of a data object. Note should be taken that the flowchart is presented in an extremely simplified manner in order to provide for a ready understanding of the present invention. In a realistic environment a multitude of processing steps could be performed in addition to the limited number of steps described herein under. At step 302 a data object movement activation event is detected. The event could be a screen event, such as the confirmation of a record update by a user, a timing event such as the detection of the expiration of a period with a pre-defined duration, or any other event associated with a major or minor processing stage involving one or more data objects. Following the detection of the activation event at step 304 source storage space is accessed via a storage space list. At step 306 the source storage space attribute map is obtained via a list of storage spaces. At step 308 the relevant data objects are extracted from the storage space. At step 310 the data objects are cloned and backed up to an archive data hub or a history data hub. At step 311 the destination storage space is determined by extracting the destination storage space identification from the global header. At step 312 the destination storage space attribute map is obtained. At step 313 the data objects are modified in accordance with the destination storage space attributes. At step 314 the data objects are inserted into the destination storage space. At step 316 the secondary records dependent on the transferred data object are located via the global header or the intelligence header of the data object. At step 318 the secondary records are backed up in an archive data hub or a history data hub and the secondary records are deleted from the source storage space thereof. At step 320 the secondary records are modified in accordance with the destination storage space attribute map definitions. At step 322 the secondary records are inserted into the destination storage space. Note should be taken that the control fields concerning inter-object connectivity may be updated where necessary according to the migration of the data objects during the transaction.

The above described sequence of operating steps are exemplary only and were presented in order to provide a coherent and ready understanding of the present invention. In other preferred embodiments of the invention the steps could be sequenced in a different manner, several of the steps could be disposed with while other step could be. Some of the steps shown as single steps typically involve the execution of one or more subroutines.

The proposed apparatus includes a protocol or regime that introduces the concept of “Influence space”. The influence space protocol is relevant for specific entities referred to as “leader” records. Influence spaces are groups of related data hubs that are maintained and managed via specific control tables in a pre-defined control storage space in metadata hubs. Metadata are also referred to as kernel hubs. Metadata hubs store various metadata definitions, such as storage space attribute tables, and the like. A leader record is a central record that resides in a data hub. A leader record has specific impacts on the subordinate records thereof. The Influence space protocol affects the related group of data hubs in the following manner. A) The leader record and the subordinate records thereof are located in a single influence space. The connection (also referred to as space connectivity) between the leader record and the subordinate records is maintained via control fields implemented within the global header. B) If the leader record leaves the influence space then the subordinate records leave the influence space as well either to another influence space or to a freezer data hub. C) When a subordinate record (on its own independent life cycle) routes to a new storage space outside the influence space the connection between the subordinate and the leader record is terminated although it can be maintained by a pointer external to the global header D) When the leader record is routed to a new influence space the connection may be revived with the subordinate records that reside in the same influence space and had previous connectivity with the routed leader record.

For example, if an employee in an exemplary influence space identified as “Current-Staff” is performing a temporary project and within the framework of the project is provided temporarily with a specific type of work-related equipment, such as, for example, a cellular phone, then the employee is represented in the project-specific influence space by a leader record and the cell phone is represented in the same project-specific influence space by a subordinate record where the records are connected. When the cellular phone is returned by the employee then the subordinate record is moved to another influence space and the connection between the employee record and the cellular phone record is broken. When the employee terminates his work on the project then the leader record associated with the employee routed from the current influence space to a new influence space. In accordance with the specific circumstances the connection between the employee record and the cellular phone record could be rebuilt.

RDBMS views could be defined from the storage space attribute maps within the influence space context. For example, a spectrum storage space “Employee” unifies data from different storage spaces having the spectrum storage space as their ancestor. Where a storage space “Current-Employee” is defined in an influence space “Current-Staff” an RDBMS view “V-Current-Employee” can be built which is a subset of the view built on the spectrum storage space “Employee”. Let us assume that an organization has 10,000 current employees and 45,000 past employees. With the “V-Current-Employee” defined on a single storage space in a data hub the RDBMS retrieves 10,000 records out of the 10,000 while with a conventional relational table with past employees are marked by a status flag status a similar view will retrieve the same 10,000 records but the population scanned will be 55,000 records.

The proposed apparatus includes one or more metadata hubs or kernel hubs divided into metadata storage spaces. Metadata storage spaces store storage space attribute maps that concern the various attributes of the storage spaces and used for the management of the storage spaces. The most significant attributes are: a) storage space type, such as spectrum storage space, data storage space, virtual storage space, and the like, b) storage space unique identification, c) data hub or regular relational database table associated with the storage space, d) influence storage space indicator, e) record schema map, f) associated intelligence header schema, g) input mode indicator, and h) user type and identifier. Additionally, an attribute map is present for the dynamic parts of the data hub fields that define the context, the security, and other functions of specific fields. Optionally, the attribute map is based upon an inheritor attribute map storing additional definitions and suppressors for specific fields.

It will be appreciated by persons skilled in the art that the present invention is not limited to what has been particularly shown and described hereinabove. Rather the scope of the present invention is defined only by the claims which follow.

1. A time-sensitive data structure configuration for divisioned life-cycle long continuous storage of data objects across intermediate storage spaces, the data structure configuration comprising:
an intermediate time-sensitive storage space associated with a storage space attribute map, for the storage of data objects routable across storage spaces during the full life-cycle of the data objects;
a storage space attribute map associated with the intermediate time-sensitive storage space, the storage space attribute map stores metadata defining the context of data columns constituting the data object stored in the storage space; and
a control header with a context specific to and associated with the data object stored in the storage space, the control header including a destination storage space identifier and a storage space attribute map extension value.

2. The data structure configuration of claim 1, wherein the control header is an embedded storage space.

3. The data structure configuration of claim 1, wherein the control header associated with a storage space enables specific operations on the data object stored in the storage space dependent on an extended context defined by the control header attribute map extension value.

4. (canceled)

5. The data structure configuration of claim 1, wherein the control header includes a context attribute for destination storage space identification to enable routing of the data object to the destination storage space.

6. The data structure configuration of claim 1, wherein the metadata further defines the context, the characteristics, and the functionality of the data columns constituting the data object.

7. The data structure configuration of claim 1, wherein the control header is context, structure, and functionality specific to the data object stored in the storage space.

8. The data structure configuration of claim 1, further includes a spectrum storage space utilized as inheritance source for the setting up of an inherited storage space, the spectrum storage space including a spectrum storage space attribute map for holding metadata defining the data columns constituting the data object stored in the inherited storage space.

9. (canceled)

10. The data structure configuration of claim 1, further includes a dynamic delta map derivation including attributes for complementing, replacing or suppressing metadata defining the data columns constituting the data object stored in the inherited storage space.

11. The data structure configuration of claim 1, wherein the data object stored in a source storage space is routable from a source storage space to a destination storage space.

12. The data structure configuration of claim 1, wherein the context, the structure, the content, and the functionality of the data columns constituting the data object are dynamically modified in accordance with the definition metadata included in storage space attribute map associated with the destination storage space during the transfer of the data object from the source storage space to the destination storage space.

13. The data structure configuration of claim 1, further comprises a global header for maintaining the identity of the data object.

14. The data structure configuration of claim 13, wherein the global header is stored in the data object.

15. The data structure configuration of claim 14, wherein the global header includes a unique life-cycle long global data object identification value, a dynamic location and time-sensitive storage space identification value, a dynamic location and time-sensitive primary key value, and a unique connectivity linkage value.

16. The data structure configuration of claim 15, wherein the unique life-cycle long global data object identification is maintained during the routing of the data object across storage spaces.

17. The data structure configuration of claim 1, wherein the data object is provided with the capability of time-dependent inter-storage space routing.

18. The data structure configuration of claim 1, wherein the data object is provided with the capability of controlled context-specific and functionality-specific self modification of the data columns included in the data object during the inter-storage routing.

19. The data structure configuration of claim 1, further comprises a data hub storing intermediate time-sensitive storage spaces.

20. The data structure configuration of claim 19, wherein the data hub is subdivided into intermediate storage spaces for the divided storage of the context-specific, characteristics-specific, content-specific, and functionality-specific data objects.

21-23. (canceled)

24. The data structure configuration of claim 1, further comprises an influence space defining a mutual domain for data objects having a storage space-based record connectivity between a primary record and a secondary record residing in data hubs table in a common influence space.

25. The data structure configuration of claim 24, wherein the influence space includes data hub tables subdivided into storage spaces.

26. The data structure configuration of claim 25, wherein the data hub tables are generated by utilizing a specific structure formula in the format n1(m1[NCD]+m2[NC]+m3 [N]+ . . . ]), where n1 and m1 are repeating factors of internal pattern, and N(numeric), C(string), and D(date time) are the basic data types used.

27-36. (canceled)

37. A method for storing information, the method comprising:
accessing a relational database, wherein the relational database comprises a plurality of relational tables and a plurality of data objects;
modifying the relational database by logically overlaying an intermediate time-sensitive storage space over each of the plurality of relational tables, wherein the intermediate time-sensitive storage space stores at least one of the plurality of data objects; and
associating a global header that is stored with the at least one of the plurality of data objects.

38. The method of claim 37, further comprising associating a storage space attribute map with the intermediate time-sensitive storage space.

39. The method of claim 37, further comprising linking a set of secondary data objects to the at least one of the plurality of data objects.

40. The method of claim 39, wherein the set of secondary data objects is provided with the capability of primary data object tracking, primary-data-object-dependent internal migration, and primary-data-object-controllable behavior.

41. The method of claim 37, wherein the global header includes at least one of: a storage space number, a data object unique identification, a pointer to other data object unique identification, a primary key, a date and time of data object registration into the intermediate time-sensitive storage space, a user code, a name of a data object, and a security filter.

42. The method of claim 41, wherein the primary key is concatenated using at least one of field values in the data objects and external computed values.

43. The method of claim 37, wherein the global header describes the migration of the at least one of the plurality of data objects.

44. An improved relational database system, including a data structure configuration complying with the rules of a relational database model, the relational database system comprising:
a relational database storing a first data object responsive to a relational data table;
at least one global header stored in the first data object including an at least one unique global data object identification value dynamically referencing the first data object having time-sensitive characteristics; and
at least one data hub logically overlaid on an at least one relational data table, the data hub logically subdivided into at least one intermediate time-sensitive storage space, wherein the intermediate time-sensitive storage space dynamically indexes the at least one global header of the first data object.

45. An improved relational database system, including a data structure configuration complying with the rules of a relational database model, the relational database system comprising:
a relational database storing a first data object responsive to a relational data table;
at least one data object reference stored in the first data object including an at least one unique data object identification value dynamically referencing the first data object having time-sensitive characteristics; and
at least one data hub logically overlaid on an at least one relational data table, the data hub logically subdivided into at least one intermediate time-sensitive storage space, wherein the intermediate time-sensitive storage space dynamically indexes the at least one data object reference header of the first data object.

46. A system for storing information, the system comprising:
a processor that is configured to:
access a data structure organized in accordance with a database model, wherein the data structure comprises a plurality of data objects that are organized in accordance with the database model;
modify the data structure by logically overlaying an intermediate time-sensitive storage space over a portion of the data structure, wherein the intermediate time-sensitive storage space stores at least one of the plurality of data objects; and
associate a global header that is stored with the at least one of the plurality of data objects.

47. The system of claim 46, wherein the data structure is one of: a hierarchical database, a network database, and a relational database.

48. The system of claim 46, wherein the processor is further configured to associate a storage space attribute map with the intermediate time-sensitive storage space.

49. The system of claim 46, wherein the processor is further configured to link a set of secondary data objects to the at least one of the plurality of data objects.

50. The system of claim 49, wherein the set of secondary data objects is provided with the capability of primary data object tracking, primary-data-object-dependent internal migration, and primary-data-object-controllable behavior.

51. The system of claim 46, wherein the global header includes at least one of: a storage space number, a data object unique identification, a pointer to other data object unique identification, a primary key, a date and time of data object registration into the intermediate time-sensitive storage space, a user code, a name of a data object, and a security filter.

52. The system of claim 51, wherein the primary key is concatenated using at least one of field values in the data objects and external computed values.

53. The system of claim 46, wherein the global header describes the migration of the at least one of the plurality of data objects.

54. A system for storing information, the system comprising:
a processor that is configured to:
access a data structure organized in accordance with a database model, wherein the data structure comprises a plurality of data objects that are organized in accordance with the database model wherein the data structure comprises a plurality of data objects that are organized in accordance with the database model;
modify the data structure by logically overlaying an intermediate time-sensitive storage space over a portion of the data structure, wherein the intermediate time-sensitive storage space stores at least one of the plurality of data objects; and
associate a global header that is stored with the at least one of the plurality of data objects, wherein the global header comprises a concatenated primary key that is generated based on field values in the at least one of the plurality of data objects.

55. An improved relational database system, including a data structure configuration complying with the rules of a relational database model, the relational database system comprising:
a relational database storing a first data object responsive to a relational data table;
at least one global header stored in the first data object including an at least one concatenated primary key value that dynamically references the first data object having time-sensitive characteristics; and
at least one data hub logically overlaid on an at least one relational data table, the data hub logically subdivided into at least one intermediate time-sensitive storage space, wherein the intermediate time-sensitive storage space dynamically indexes the at least one global header of the first data object.

56. A method for storing information, the method comprising:
accessing a relational database, wherein the relational database comprises a plurality of relational tables and a plurality of data objects, the plurality of data objects comprises a primary record and one or more secondary records;
modifying the relational database by logically overlaying an intermediate time-sensitive storage space over each of the plurality of relational tables;
modifying the relational database by creating influence spaces, wherein each influence space defines a mutual domain for data objects having a storage space-based record connectivity between the primary record and the one or more secondary records and wherein the primary record and the one or more secondary records reside in the same influence space; and
in response to transferring the primary record to another influence space, maintaining the connectivity between the primary record and the one or more secondary records.

57. A method for storing information, the method comprising:
accessing a database comprising a plurality of relational tables and a plurality of data objects, the plurality of data objects comprises a primary record and one or more secondary records;
providing influence spaces defining a domain for data objects having a storage space-based record connectivity between the primary record and the one or more secondary records, wherein the primary record and the one or more secondary records reside in the substantially same influence space; and
in response to transferring the primary record to another influence space, maintaining the connectivity between the primary record and the one or more secondary records.
